(19) United States
(12) Patent Application Publication
(10) Pub. No.: US 2005/0055632 A1
(43) Pub. Date: Mar. 10, 2005

(54) Method of producing and delivering an electronic magazine in full-screen format

(76) Inventors: Daniel M. Schwartz, Burlingame, CA (US); Patrick E. Kenny, Putnam Valley, NY (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/828,252

(22) Filed: Apr. 21, 2004

Related U.S. Application Data
(60) Provisional application No. 60/496,155, filed on Aug. 18, 2003.

(51) Int. Cl. G06F 17/00; H04N 7/00; H04N 7/16; H04N 7/173; G06F 17/24; G06F 17/21; G06F 15/00; H04N 11/00

(52) U.S. Cl. 715/513; 715/501.1; 715/500.1; 725/135; 725/109; 725/110; 725/112

(57) ABSTRACT

A method for producing and electronically distributing a digital magazine for onscreen viewing using a standard browser converts or renders an original document, which can be in a print format or in a digital format, to a format suitable for full-screen viewing on a display screen. The conversion or rendering includes reformatting the original document from the portrait format to the landscape format, if necessary. The digital magazine is displayed in a full-screen manner, which hides the toolbar(s) of the standard browser. To navigate the digital magazine, a navigation bar is embedded into each page of the digital magazine. The digital magazine is delivered to subscribers as an attachment to an e-mail message or as a URL link within an e-mail, which, when clicked on, downloads the digital magazine to the subscribers' computers.

### CROSS REFERENCE TO RELATED APPLICATIONS

The present application claims benefit under 35 U.S.C. § 119(e) of U.S. Provisional Application No. 60/496,155, filed Aug. 18, 2003, the entire disclosure of which is incorporated herein by reference.

### BACKGROUND OF THE INVENTION

1. Field of the Invention

The present invention relates generally to providing a digital magazine to be viewed on a display screen, and, more particularly, to rendering a printed magazine into a digital magazine that is compatible with a screen of a computer monitor or a television or the like, such that the digital magazine is displayed in a full-screen manner.

2. Related Art

Electronic publishing and distribution embraces many different commercially available computer programs (software) known in the art. Software has been developed that is specifically designed to electronically publish and distribute (deliver) digital publications using the Internet. This software was designed to process documents in the format of conventional paper (print) publications, which typically is the so-called portrait format. This software does not, however, process documents so that the resulting digital publications are formatted to be conveniently viewed on a screen of a computer monitor or a television or the like, which typically are in the so-called landscape format.

As used herein, a digital publication is either an electronic version of a print publication, or a publication that is created exclusively for the screen but (thought of as, treated as, marketed as, consumed as) a print publication. Digital publications include publications available online via the Internet, publications stored on an electronic storage medium, such as a hard drive, a DVD, a floppy disk, and the like, and publications delivered digitally via cable or wireless transmissions.

As used herein, a digital magazine is a digital publication having rich graphics integrated therein, such as photographs, artwork, illustrations, and the like, and optionally may include embedded audio and/or video content, internal links, external hyperlinks, and a search function enabling searching within the digital magazine itself, other issues of the digital magazine, as well as other digital publications. Typically, advertisements and a table of contents are incorporated in a digital magazine. Included in the category of digital magazines are digital newspapers. A digital magazine is viewed on a display screen, such as that of a computer monitor, a television, a personal digital assistant, a cinema, and other screen-based media.

As used herein, a reader program is software for processing and displaying a digital publication on a display screen.

Conventional systems for publishing and/or viewing digital publications have several problems, including those relating to standardization, formatting, and ease of use. Presently, there is no standard platform for publishers to electronically present their publications to subscribers. Some digital publications may be viewed using commonly available browsers, while other digital publications require the use of proprietary reader programs, which must be installed by subscribers in their computer systems in order for proprietary file extensions of those digital publications to be recognized (readable) by those computer systems. Moreover, the proprietary reader programs do not support all available computer operating systems.

In general, print magazines are designed and distributed with each page being a “vertical” page, in the portrait format, with the height being greater than the width. Display screens, however, generally are “horizontal,” with the width being greater that the height. This makes a digital magazine that is an exact replica of its print counterpart difficult or awkward to read on a display screen.

Conventional systems for publishing and/or viewing a digital magazine operate to exactly replicate the counterpart print magazine for viewing on a display screen. This approach makes reading the digital magazine difficult, because the font size of the print version generally is too small for onscreen reading. Therefore, a user must manipulate the digital magazine with special functions, including functions for zooming in/out and scrolling left/right, for example, to be able to read the text therein. Also a user must perform manipulations to be able to view graphics that span two facing pages, which is a type of graphics layout common in print magazines, and to view multi-page spreads, such as fold-out pages often found in print magazines.

Currently, conventional browsers and reader programs utilize a toolbar located at the top, bottom, and/or side of a display screen to navigate a digital publication. These may not be the most suitable positions for manipulating pages of a digital magazine. Further, most of the typical tools (functions) available on such conventional toolbars are irrelevant to a user viewing a digital magazine. Furthermore, such conventional toolbars are hidden and thus are not conveniently accessible when viewing a digital magazine presented in a full-screen manner.

Adobe® Acrobat® and Microsoft® Internet Explorer™, which currently are two of the standard browsers most widely in use, do not attempt to solve the above-noted problems for publishing and/or viewing digital magazines. Instead, these browsers rely on their standard reader functions for displaying documents and e-books, i.e., for situations in which the challenges of presenting multi-page spreads, facing pages, advertisements, and a table of contents that is directly linked to its' respective articles, do not exist.

Presently, most digital magazines use a “Portable Document Format” (PDF format) platform, or a clone thereof, which compresses an electronic version of a print document while maintaining its original print-version layout. The focus to date has been on delivering, via the Internet, an exact replica of a print (paper) magazine in electronic form. This replicated format, however, makes the magazine cumbersome to read on a display screen, for at least the reasons mentioned above.

One proprietary PDF-based reader program, which must be separately installed on a user's computer, attempts to provide a more user-friendly experience by duplicating as closely as possible the experience of reading a paper magazine on a display screen. This reader program provides functions that differ from those of the Adobe® Acrobat® browser, and allows for viewing of each page individually or a spread of two facing pages. Another function of this reader program allows for background sound effects.

One of the drawbacks of the PDF-based reader program discussed above is that, to be able to read the text on a page, a user must click on the page at the location of the text to zoom in. Similarly, the user must click again to return to the individual-page or two-page format.

Another proprietary PDF-based reader program focuses on publishing and viewing digital newspapers. Similar to the reader program discussed above, this reader program also must be separately installed on a user's computer, and a user also must perform manipulations to a displayed page to zoom in to read desired text.

Some digital magazines use reader programs based on HTML or XML protocols, and thus are not PDF-based. These non-PDF-based reader programs, however, suffer from the same inconveniences of requiring user manipulation to zoom in on the location of desired text in order to read that text, and then to zoom out to continue viewing the digital magazine.

In addition to the problems mentioned above, reader programs that presently are commercially available have other problems, including requiring extra software downloads or installations, requiring users to learn how to use the software, not being able to process and display digital documents that were not created for viewing by those reader programs, not allowing printing of specific page ranges, not allowing searches across different publications or documents, being designed for displaying documents in the portrait format, and supporting a limited number of operating systems.

One version of server-driven software for electronic publishing and viewing a digital publication relies on a server to feed content to a shortened electronic version of an original publication. A user clicks on an article that appears to be the original publication but is only a visual summary. The user is then hyperlinked to the full digital publication.

Another version of server-driven software for electronic publishing and viewing allows publishers to distribute digital publications online, in its original format. A digital magazine is produced from a final print version of the magazine utilizing Postscript or PDF files. After the print version is distilled into XML data, the XML data is enriched with hyperlinks, META tags, and other online-specific features. The digital magazine produced by such software may be viewed through a standard browser.

One common problem of the server-driven software discussed above is that their built-in reader units cannot render a digital magazine to properly fit a display screen. Also, digital magazines produced by such software only can be read by a user while connected to the Internet.

### SUMMARY OF THE INVENTION

The present invention overcomes the above-noted problems of the prior art by providing, in a preferred embodiment, an integrated solution for displaying a digital magazine in a full-screen manner using a standard browser, including (but not limited to) Adobe® Acrobat® and Microsoft® Internet Explorer™, for example. The digital magazine is converted or rendered from an original document, which can be in a print format or in a digital format, to a format suitable for full-screen viewing on a display screen. The conversion or rendering includes reformatting the original document from the portrait format to the landscape format, if necessary. The digital magazine is displayed in a full-screen manner, which hides the toolbar(s) of the standard browser and thus increases the area for displaying the digital magazine. To navigate the digital magazine, a convenient and easy to use navigation bar is embedded into each page of the digital magazine at any desired position. The digital magazine is distributed (delivered) electronically to subscribers as an attachment to an e-mail or as a URL link within an e-mail, which, when clicked on, downloads the digital magazine to the subscribers' computers. This avoids the need to be connected to the Internet to be able to view the digital magazine.

### BRIEF DESCRIPTION OF THE DRAWINGS

The present invention will be more readily understood from a detailed description of the preferred embodiments considered in conjunction with the following figures.

FIG. 1 is a view of a cover page of a magazine in portrait format;

FIGS. 2A and 2B is a view of a cover page of digital magazine cover in portrait format and landscape format, respectively, corresponding to the view of FIG. 1A;

FIG. 3 shows a flow chart summarizing a process for producing a digital magazine according to an embodiment of the present invention.

FIG. 4 shows a flowchart summarizing a back-end process for delivering a digital magazine according to an embodiment of the present invention.

FIG. 5 shows a flowchart summarizing a process for converting a print magazine to a digital magazine according to an embodiment of the present invention.

FIGS. 6A and 6B shows a left-side portion and a right-side portion, respectively, of a two-page spread of a print magazine.

FIG. 7 shows a repurposed page in portrait format corresponding to the two-page spread of FIGS. 6A and 6B.

FIG. 8 shows a repurposed page in landscape format corresponding to the two-page spread of FIGS. 6A and 6B.

### DETAILED DESCRIPTION OF THE PREFERRED EMBODIMENTS

In a preferred embodiment, the present invention provides a system for producing and delivering a digital magazine, which is presented in a full-screen manner, that solves the shortcomings of the prior art. The system operates on an open platform that is compatible with commercially available and widely distributed browsers and reader programs, including Microsoft® Internet Explorer™ and Adobe® Acrobat®, for example. The system does not interfere with the existing functionality of such browsers and reader programs, but instead operates in conjunction with them. Further, because such browsers and reader programs generally are pre-installed on most computers, there is no need to obtain and install any specialty (proprietary) software in order to view the digital magazine.

The system produces a digital magazine for onscreen viewing that can easily be read on a display screen in the landscape format and in a full-screen manner, i.e., without any borders and with the toolbar(s) of the browser or reader program hidden. The format of the digital magazine produced according to the present invention is referred to herein as the repurposed format. An example of such a repurposed format is the “QuVu”™ format.

When the system produces a digital magazine from an original print magazine, instead of exactly replicating the print magazine for onscreen viewing, the system repurposes (reformats) it so that the resulting digital magazine is in the repurposed format.

According to an aspect of a preferred embodiment of the present invention, a digital magazine is rendered such that a user can read an article onscreen just as easily and naturally as if reading the article printed on paper. If the digital magazine is based on a print magazine, the content of the print magazine is repurposed such that the text is in a font size suitable for onscreen viewing, i.e. at least a 10-point font size. Also, all the graphics of the print magazine are repositioned and/or re-sized, as needed, and the layout of the print magazine is rearranged to fit a full screen. This allows the user to view the resulting digital magazine without having to perform excessive manipulations, i.e., without requiring constant zoom-ins and zoom-outs, and page scrolls up/down and left/right, etc.

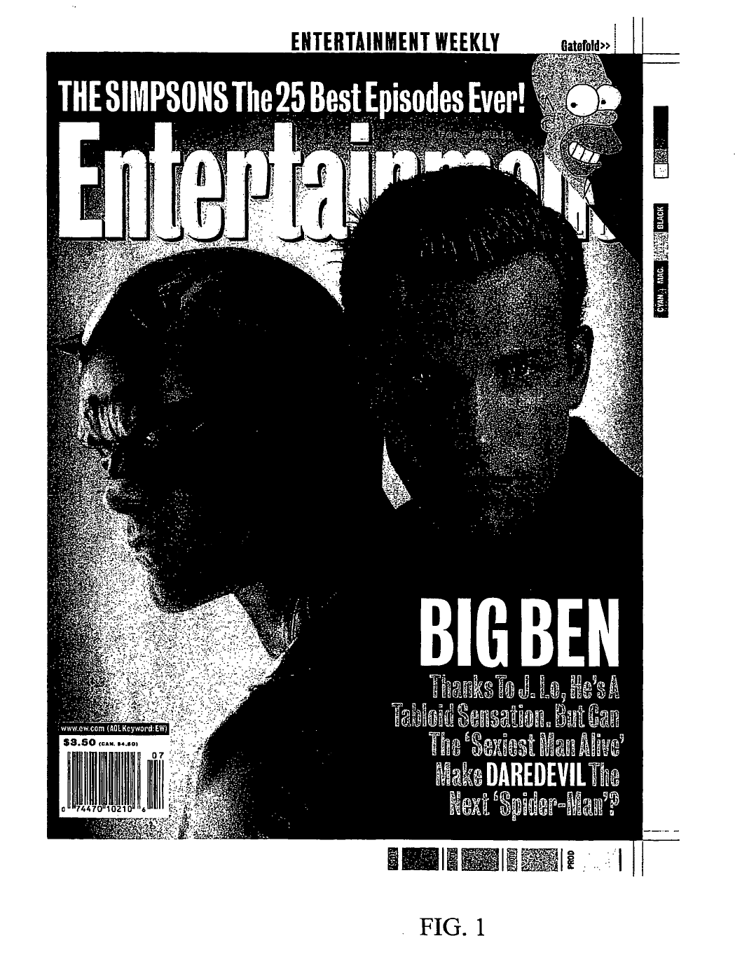

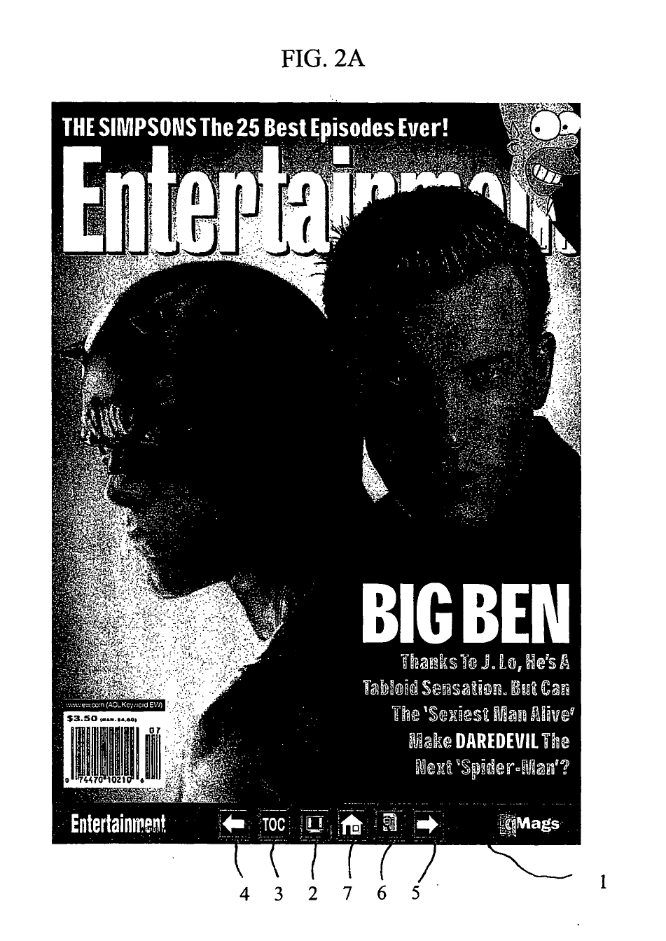

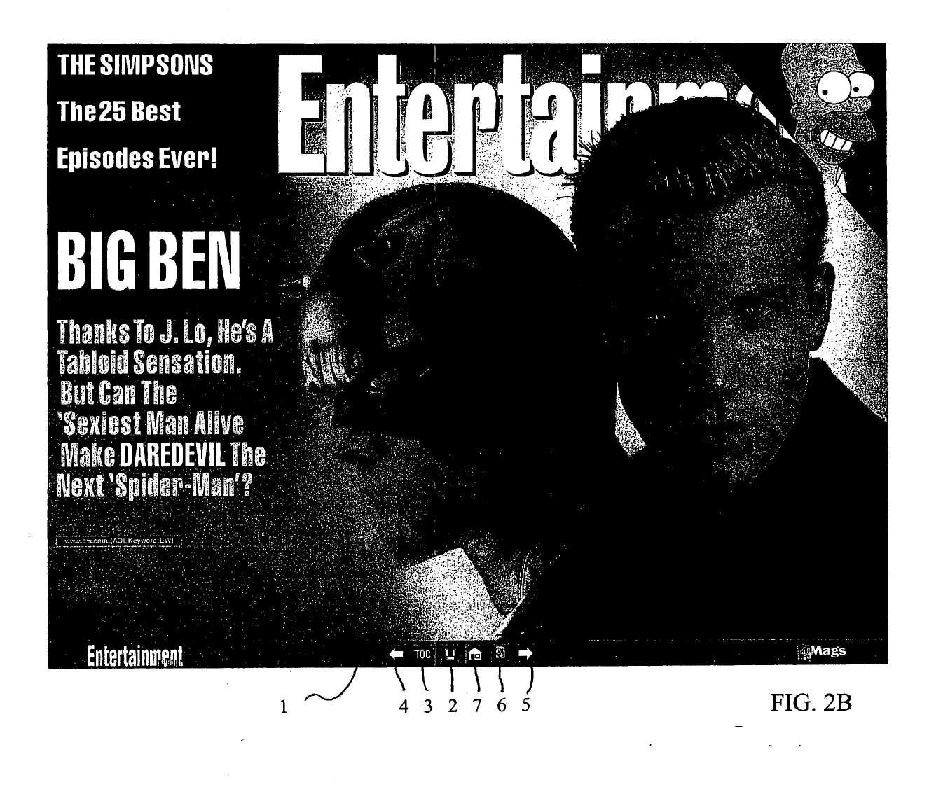

FIG. 1 shows an example of a cover page of a print magazine. FIGS. 2A and 2B show examples of the cover page repurposed to the repurposed format. In the example of FIG. 2A, the repurposed cover page retains the portrait format of the print magazine, which is useful for some vertically oriented display screens whose height is greater than their width. In the example of FIG. 2B, the cover page has been repurposed from the portrait format to the landscape format typical of most display screens, without sacrificing any text or graphics from the print version.

The repurposed format shown in FIGS. 2A and 2B facilitates onscreen viewing by presenting all the content of the print version of the cover page in a manner that minimizes the need for zooming and/or scrolling operations. In contrast, if an exact replica of the cover page of FIG. 1 is produced for onscreen viewing on a typical display screen, i.e., a display screen that is wider than it is long, a user would have to scroll up/down to see the top/bottom portions of the cover page, making the viewing experience inconvenient for the user.

As discussed above, the repurposed format presents a digital magazine in a full-screen manner, which hides the toolbar(s) of the underlying browser or reading program used to view the digital magazine. Instead, in the repurposed format, a navigation bar is integrated into the digital magazine. This allows the navigation bar to be customized for the digital magazine to indicate, for example, the name of the magazine, the issue, regularly occurring features, etc.

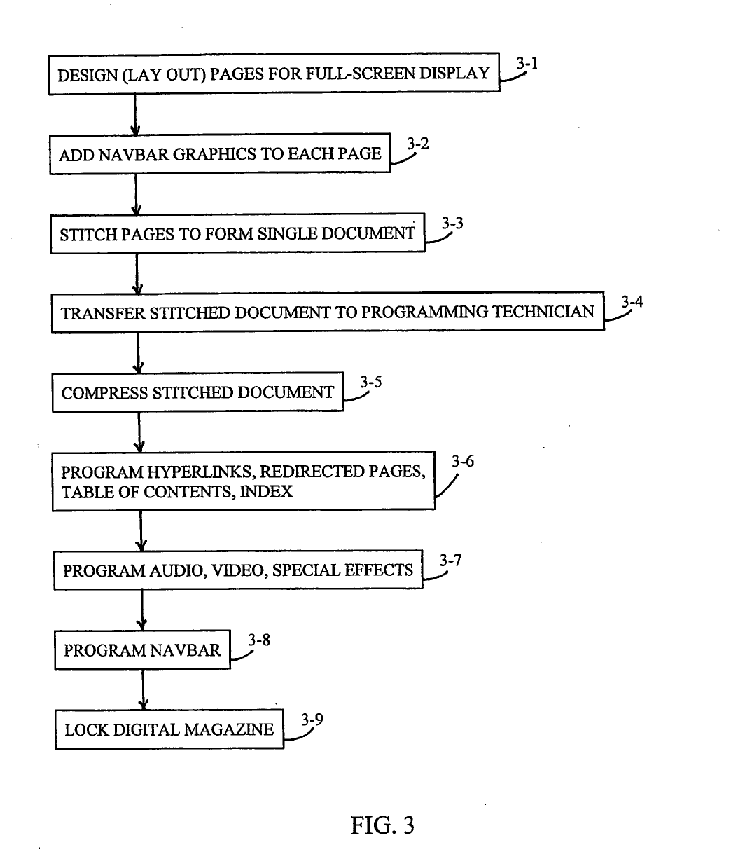

FIG. 3 summarizes the process of creating a digital magazine from pages laid out in the repurposed format.

In step 3-1, the text and graphics, i.e., all the viewable features, of each page of the magazine are designed (laid out) to fill a full display screen in the landscape format, e.g., in a height:width (aspect) ratio of 3:4. Similarly, if a portrait format is desired, the text and graphics are laid out for full-screen viewing in an aspect ratio typical of a portrait-oriented display screen, e.g. 4:3.

Because magazines generally have sections that are common from issue to issue, layout specifications (templates) for those sections may be set in advance. For example, if a magazine has a Letters to the Editor section in every issue, then the graphics (e.g., title artwork) for that section, the areas reserved for advertisements, and the area for presenting letters from subscribers may be designed in advance as the layout specification. This allows the appearance of the section to be uniform from issue to issue. To complete the layout of the page, a technician merely has to insert, for each issue of the magazine, the advertisements and the text of the letters in the areas reserved therefor.

Similarly, if the magazine has a Table of Contents (TOC) page, then the layout specification for the TOC page may be set in advance, so that a technician merely has to insert graphics, text, and/or advertisements for the page that are pertinent to the issue of the magazine being laid out.

Commercially available software for electronic publishing may be used to lay out the pages of the magazine, such as Adobe® Pagemaker®, for example. The pages need not be laid out in sequence.

In step 3-2, the graphics of a navigation bar (NavBar) is added to each page of the magazine. An example of a NavBar is shown as reference numeral 1 in FIGS. 2A and 2B. At this stage, the functions shown in the graphics of the NavBar are not yet operational. The graphics merely show the appearance of the NavBar, which may be embedded anywhere on the page depending on the desired “look and feel” of the digital magazine. The design and placement of the NavBar are accomplished using commercially available software, such as Adobe® Photoshop® or Adobe® Illustrator®, for example.

In step 3-3, all the laid-out pages of the magazine are sequentially linked (stitched) to form a single digital document using commercially available software.

Steps 3-1 to 3-3 may be performed by a publisher that does not have expertise in software programming and/or the processing of digital files. If that is the case, in step 3-4, the stitched digital document is transferred to a programming technician using any known technique for electronically transferring files, or by copying the stitched document onto a recording medium and manually delivering the recording medium to the programming technician. If the publisher is able to handle the programming and/or processing of the digital files, then step 3-4 may be omitted, because the publisher performs the tasks of the programming technician.

Optionally, accompanying the stitched document are files for audio and/or video clips to be added to the digital magazine, as well as instructions regarding hyperlinks and redirected pages.

In step 3-5, the programming technician arranges for the stitched document to be electronically compressed to reduce its storage size. For example, JPEG and TIFF compression techniques may be used to reduce the storage size of graphics.

In step 3-6, the programming technician programs any hyperlinks and redirected pages in the stitched document. For example, hyperlinks are programmed to enable a user to electronically access external sites, such as web sites of advertisers, from the digital magazine. Similarly, the programming technician programs the stitched document to redirect a user to other pages with related graphics or a related article, for example. Additionally, the programming technician enables the TOC page so that a user can jump directly from the TOC page to a selected article or section. If a topic index is included, the programming technician enables the index so that a user can jump to a page with a selected topic.

In step 3-7, the programming technician programs any audio and/or video clips provided with the stitched document. For example, if an article in the stitched document relates to a newly available music CD, and an audio clip is provided with the stitched document, the programming technician adds the audio clip to the article so that when a user views the article the audio clip is played on speakers associated with the user's display screen. Similarly, if an audio/video clip is provided, the programming technician adds the audio/video clip to the article so that when a user views the article a window in the article displays the video portion of the clip while the audio portion is played on the speakers. Additionally, if other special effects are required, such as pop-up pages and automatic zooming, they are programmed in step 3-7.

In step 3-8, the programming technician programs the NavBar to make each of the functions shown thereon operational. All the functions of the NavBar derive from the functionality of the underlying reader program used to view the digital magazine.

As mentioned above, the NavBar is customizable for each magazine. That is, not only is the look of the NavBar customizable, the navigation functions that may be performed via the NavBar also may be custom selected to suit the magazine. Optionally, each page of the digital magazine may have a NavBar customized for that page.

The NavBar functions may include, for example, zooming in/out; toggling between a full-screen display mode and the default display mode of the underlying reader program 2; jumping to the TOC 3; paging forward/backward 4, 5; jumping to a previous/subsequent section; printing; linking to a searching routine 6; linking to an external web site; jumping to the cover page 7; etc. That is, the NavBar is a general-purpose tool that may be used to access different types of digital information and computer-based applications. The NavBar enables a user to navigate within the digital magazine as well as to external links, including web sites, network devices, files, and directories, for example. The NavBar is operated through any type of pointing device, such as a keyboard, a mouse, a remote mouse, a TV remote controller, and the like.

The programming of the NavBar may be accomplished using known techniques, such as Java scripting, for example. The underlying reader program enables manipulation of a viewed document using JAVA scripts. Each button on the NavBar is programmed with its own JAVA script that activates one or more desired functions of the reader programs. For example, when a zoom-in function is programmed, in order to zoom properly, the JAVA script for that function will cause the reader program to: (1) go to the appropriate page; (2) fit the page to the width of the display screen; (3) go to the top of the page. A JAVA script for a corresponding zoom-out (unzoom) function reverses these steps.

The programming of the NavBar and other functions of the digital magazine, such as audio, video, and other special effects, takes into account and provides for backwards compatibility with older versions of the reader program.

Once all the programming for the digital magazine is completed, the programming technician locks the digital magazine in step 3-9. This prevents the digital magazine from being altered.

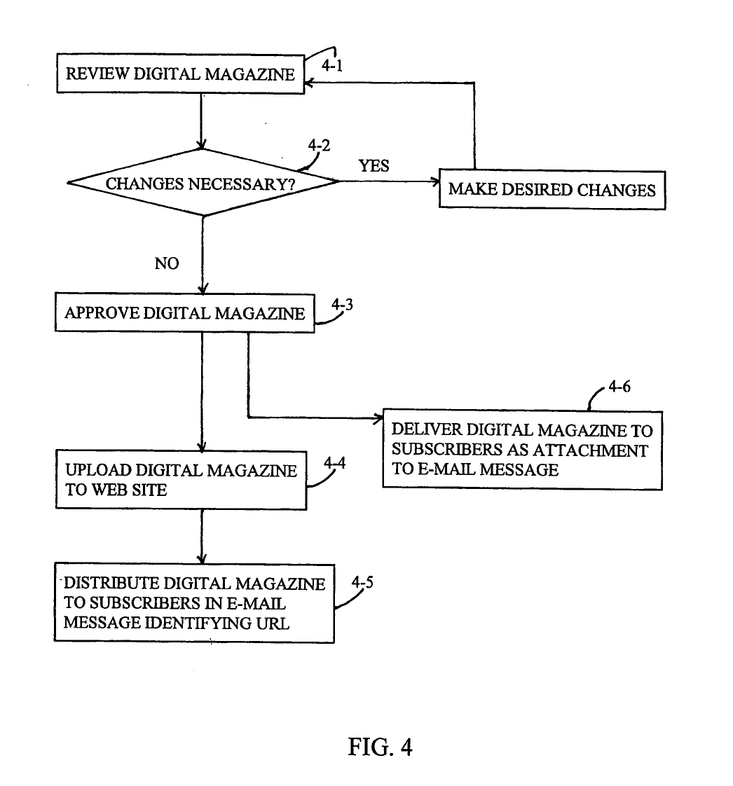

FIG. 4 shows a flowchart summarizing a back-end process of the present invention.

In step 4-1, the programming technician provides the locked digital magazine to the publisher for review approval. If the storage size of the magazine is small, it may be transmitted to the publisher as an attachment to an e-mail message. If the storage size is too large to be an e-mail attachment, the digital magazine is loaded in a publication-preview section of a web site, and the publisher is given a URL to access that web site. From the web site, the publisher may download the magazine for preview or may preview the magazine directly from the web site. Optionally, any other known technique for electronically transferring files may be used.

In step 4-2, the publisher informs the programming technician of any corrections to be made. This can be done via e-mail messages or any other means of communication.

Once the publisher approves the digital magazine, the programming technician is informed of the approval, in step 4-3. The programming technician then arranges to electronically distribute the digital magazine. This is accomplished by placing the digital magazine on a web site, in step 4-4. If a previous issue of the digital magazine exists on the web site, the previous issue is moved to an archive location and the newly created current issue of the digital magazine is installed as the main content of the web site.

In step 4-5, the programming technician distributes the digital magazine to its subscribers by sending each subscriber an e-mail message identifying a unique URL that, when accessed, causes the digital magazine to download to the computer accessing the URL. In this way, a subscriber or user can view the digital magazine offline, i.e., without being connected to the Internet. Known programming techniques may be used to implement the automatic downloading.

Optionally, instead of steps 4-4 and 4-5, if the storage size of the digital magazine is sufficiently small, the programming technician distributes the digital magazine by delivering it as an attachment to an e-mail message sent to each subscriber, in step 4-6.

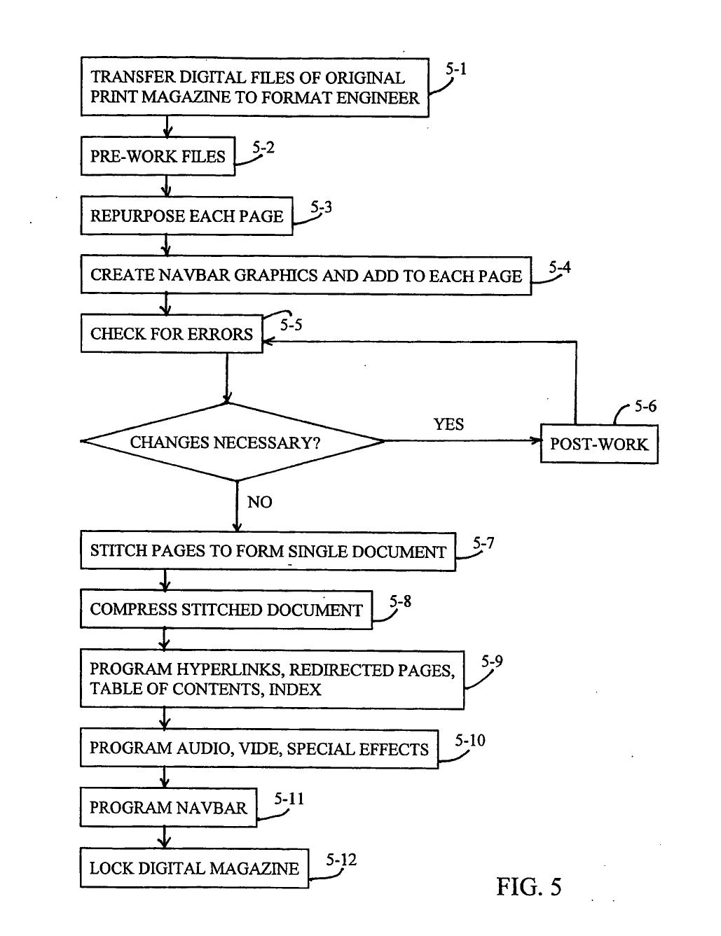

FIG. 5 summarizes the process of converting an original print magazine to a digital magazine in the repurposed format. The conversion requires extensive reworking of the print magazine. Certain parts of the conversion may be automated, i.e., it may be performed using software, while other parts are done manually.

The print magazine can be created by any known means. According to an embodiment of the present invention, the print magazine is created in the portrait format using commercially available publishing software for electronic publishing.

In step 5-1, digital files corresponding to the print magazine are transferred to a format engineer using any known technique for electronically transferring files, or by copying the files onto a recording medium and manually delivering the recording medium to the format engineer.

Preferably the files provided to the format engineer are created with Quark™ software or by using Adobe® InDesign®, such that all fonts are embedded in the files and any desired hyperlinks are included in the files. If other types of files are provided to the format engineer, such as PDF files, for example, then the format engineer must “dismantle” or each page and effectively recreate each page with the fonts embedded and the hyperlinks included.

Once any necessary page recreation is completed, the files are pre-worked in step 5-2. Pre-working involves editing the graphics that appear in the print magazine by manipulating the files for the graphics. This includes re-linking portions of an image into its native file, which entails re-combining into a single file all the fragmented portions of the graphics for the image stored in different files. For example, the graphics for an image that is split across a multi-page spread is recombined and/or extended into a single file for that image. Pre-working also includes extracting all the images from a file that includes other data, such as text, for example, and storing each extracted image in its own file This may also include re-created portions of the image beyond the original mask or bleed to fit the resized image to repurposed format. Any commercially available software may be used for pre-working, including photo-editing software and graphics (drawing) software.

In step 5-3, the layout of each page of the print magazine is repurposed to the repurposed format. This includes formatting each page to be displayed in a full-screen manner in the landscape format, with titles, graphics captions, and other text appearing in respective font sizes appropriate for onscreen viewing, and with any graphics re-sized for the page. The graphics may be laid out such that an image appears on its own page or with text appearing on the same page.

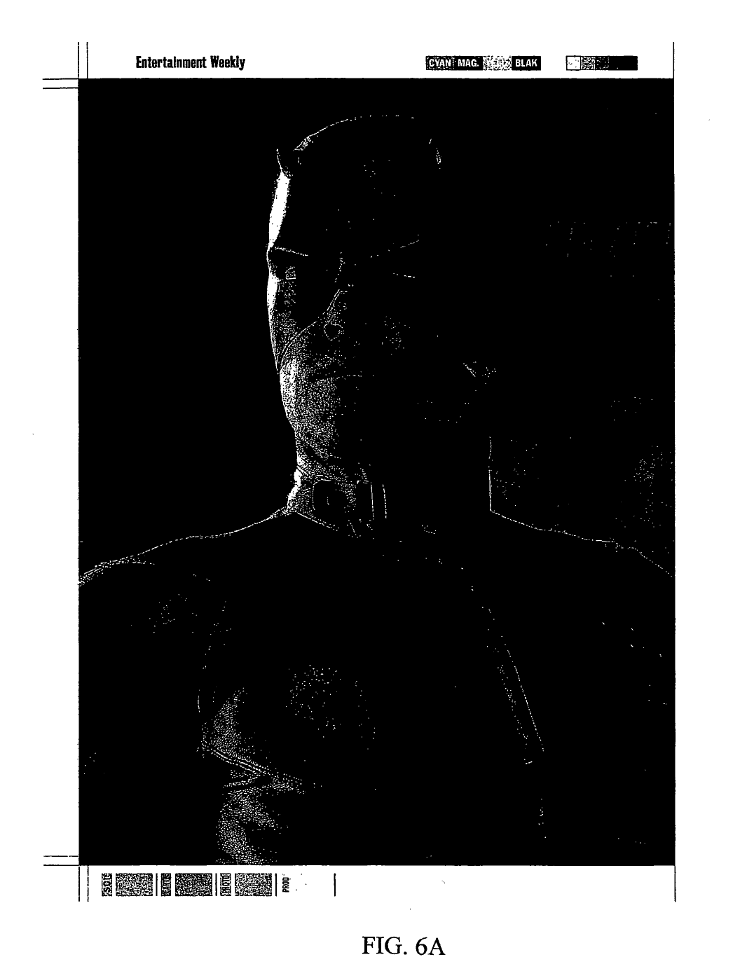

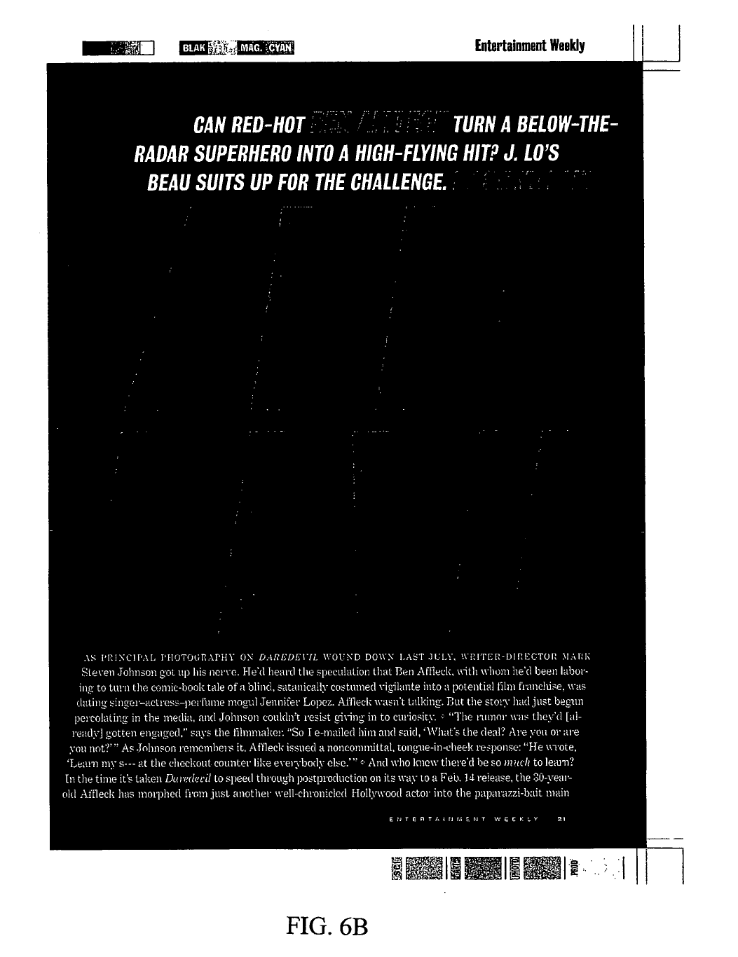

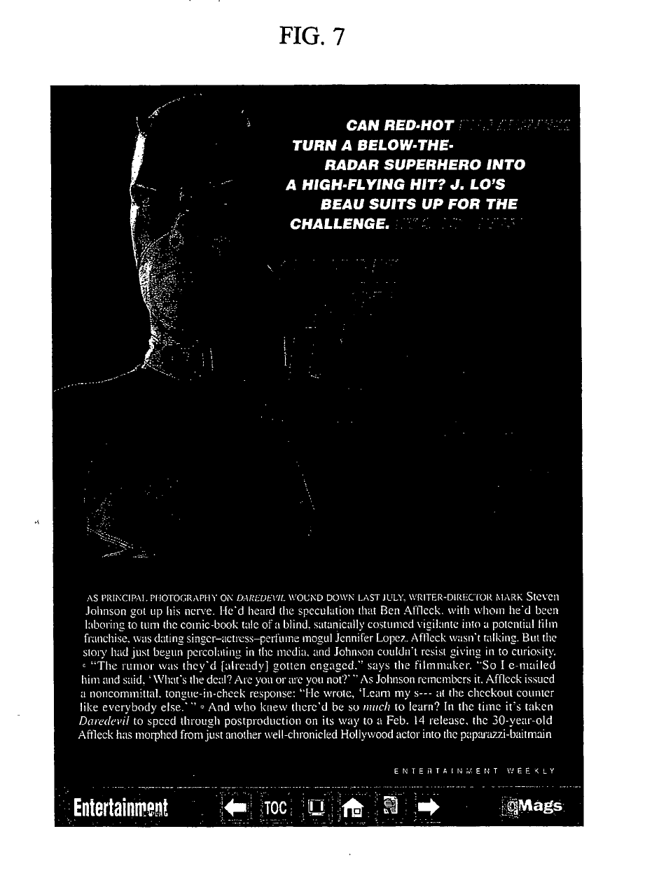

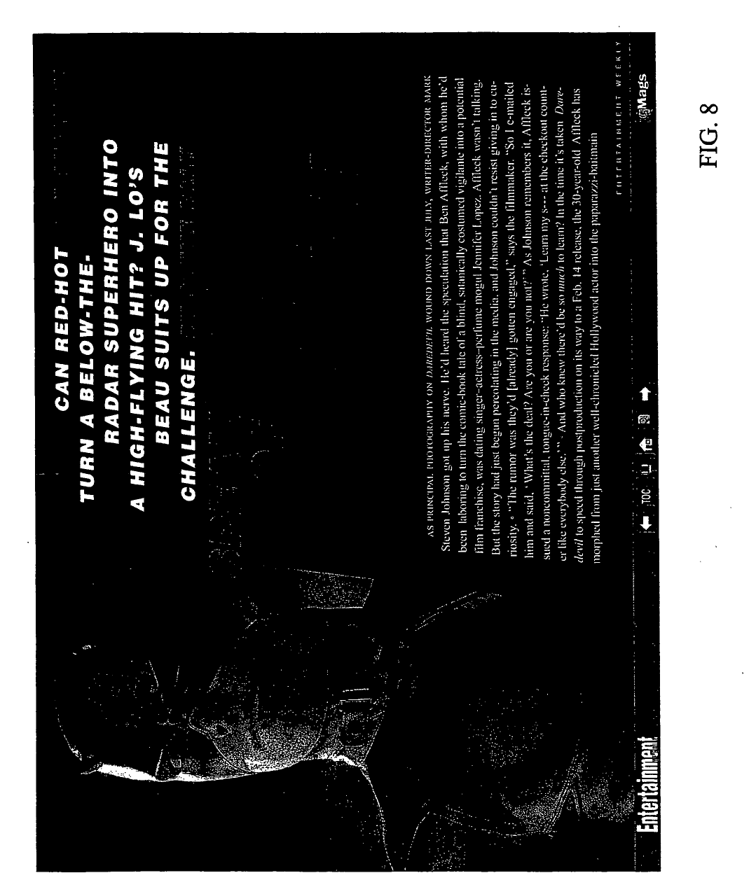

FIG. 6A shows a left-side portion of a two-page spread of a print magazine; and FIG. 6B shows a corresponding right-side portion thereof. When this two-page spread is repurposed to the repurposed format, the resulting repurposed page is shown in FIG. 7 (for the portrait format) and FIG. 8 (for the landscape format). As can be seen by comparing FIGS. 6A and 6B with either FIG. 7 or FIG. 8, the graphics for both pages of the two-page spread have been recombined so that the depicted image can be viewed in a convenient manner on a display screen, without having to turn any pages to view the complete image. Additionally, the text from the two-page spread has been re-sized and repositioned on the repurposed page for easy onscreen reading.

According to an embodiment of the present invention, an art director re-works each page of the print magazine by making a “scribble” of the repurposed (revised) layout for each page. The scribble shows the basic design of the re-worked page. The scribble is transferred to a technician, who executes the design to create a digital file of that page in the repurposed format, i.e., the repurposed page.

Optionally, templates may be used to automate the page-layout process. Templates are especially useful for magazines that have features (and layout formats) that recur in each issue. This approach works best when there is a fair amount of consistency across issues, and is more likely to work with regular magazine features than articles, which tend to have unique designs. Aside from saving time, templates give the digital magazine a high level of consistency across issues.

In step 5-4, similar to step 3-2, the graphics for a NavBar is created and embedded on each repurposed page.

In step 5-5, each repurposed page is checked for errors, including making sure that none of the text from the print magazine has been omitted or placed in a wrong location. The checking is essential because, depending on the electronic-publishing software used, different types of text, such as main text, figure captions, and titles, for example, may be stored in different files from each other or simply lost in the repurposing process. This can result in text appearing in the wrong location on a repurposed page.

In step 5-6, if it is determined that changes are desired on one or more pages, those pages are post-worked to implement the changes and then re-checked.

In step 5-7, all the repurposed pages are stitched to form a single digital document using commercially available software.

In step 5-8, the stitched document is electronically compressed to reduce its storage size using compression techniques such as JPEG or TIFF, for example.

In step 5-9, any hyperlinks and redirected pages in the stitched document are programmed.

In step 5-10, any audio and/or video clips or other special effects associated with the digital magazine are programmed.

In step 5-11 the NavBar is programmed to make each of the functions shown thereon operational. The programming may be accomplished using known techniques, such as Java scripting, for example. As discussed above, the NavBar is customizable for each magazine and optionally is customizable for each repurposed page

Optionally, the order of the steps in FIG. 5 may be interchanged.

Once all the programming for the digital magazine is completed, the digital magazine is locked in step 5-12 to prevent alteration.

Subsequently, the locked digital magazine follows the back-end process summarized in the flowchart of FIG. 4, discussed above.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

For example, although the repurposing and delivery of magazines is discussed herein, the scope of the present invention also includes the repurposing and delivery of other types of periodicals for onscreen viewing.

1. A method for producing and distributing a digital magazine, comprising the steps of:
electronically laying out a plurality of pages such that each page fully fits a display screen;
electronically inserting in each page of the digital magazine graphics for a navigation bar, wherein the graphics for the navigation bar shows a plurality of functions;
combining the plurality of pages to form a single document;
programming the navigation bar to be operational, such that each of the plurality of functions shown thereon may be activated upon selection with an electronic pointing device;
storing the document with the operational navigation bar in an electronic storage device as the digital magazine; and
electronically distributing the digital magazine to a plurality of subscribers.

2. The method according to claim 1, wherein the step of electronically distributing the digital magazine includes electronically transmitting to each of the plurality of subscribers the digital magazine as an attachment to an e-mail message.

3. The method according to claim 1, wherein the step of electronically distributing the digital magazine includes transmitting to each of the plurality of subscribers an e-mail message with a URL for accessing the electronic storage device storing the digital magazine.

4. The method according to claim 3, wherein the URL is a hyperlink and, when a subscriber activates the hyperlink from a computer, the digital magazine is automatically downloaded from the electronic storage device to the computer.

5. The method according to claim 1, wherein the step of electronically laying out a plurality of pages includes:
obtaining electronic files corresponding to an original print magazine;
recombining fragmented portions of a graphics image stored in multiple ones of the electronic files into a single electronic file; and
reformatting and repositioning at least one of text and graphics, which appear across multiple pages of the original print magazine, to appear on the display screen as a single page of the digital magazine.

6. The method according to claim 1, wherein the display screen is oriented in a landscape format.

7. The method according to claim 1, wherein the display screen is oriented in a portrait format.

8. The method according to claim 1, further comprising the step of programming at least one of a hyperlink, a redirected page, an audio clip, and a video clip into the digital magazine.

9. The method according to claim 1, wherein the step of electronically laying out a plurality of pages includes utilizing a template to lay out one or more areas of a page.

10. The method according to claim 1, further comprising the step of compressing a storage size of the digital magazine before storing the digital magazine in the electronic storage device.

11. A method for producing and distributing a digital magazine, comprising the steps of:
obtaining electronic files corresponding to an original print magazine;
reformatting and repositioning at least one of text and graphics, which appear in a portrait format in the original print magazine, to appear on a display screen in a landscape format;
electronically laying out a plurality of pages such that each page fully fits a display screen;
electronically inserting in each page of the digital magazine graphics for a navigation bar, wherein the graphics for the navigation bar shows a plurality of functions;
programming the navigation bar to be operational, such that each of the plurality of functions shown thereon may be activated upon selection with an electronic pointing device;
storing the plurality of pages, each with the operational navigation bar, in an electronic storage device as the digital magazine; and
electronically distributing the digital magazine to a plurality of subscribers.

12. The method according to claim 11, wherein the step of electronically distributing the digital magazine includes electronically transmitting to each of the plurality of subscribers the digital magazine as an attachment to an e-mail message.

13. The method according to claim 11, wherein the step of electronically distributing the digital magazine includes transmitting to each of the plurality of subscribers an e-mail message with a URL for accessing the electronic storage device storing the digital magazine.

14. The method according to claim 13, wherein the URL is a hyperlink and, when a subscriber activates the hyperlink from a computer, the digital magazine is automatically downloaded from the electronic storage device to the computer.

15. A method of distributing a digital magazine, comprising the step of electronically transmitting an e-mail message to each of a plurality of subscribers of the digital magazine, wherein, depending on a storage size of the digital magazine, the digital magazine is:
transmitted as an attachment to the e-mail message, or
automatically downloaded to a computer when a hyperlink included in the e-mail message is activated by a subscriber using the computer.

16. A method for producing a digital magazine, comprising the steps of:
electronically laying out a plurality of pages such that each page fully fits a display screen;
electronically inserting in each page of the digital magazine graphics for a navigation bar, wherein the graphics for the navigation bar shows a plurality of functions;
programming the navigation bar to be operational, such that each of the plurality of functions shown thereon may be activated upon selection with an electronic pointing device; and
storing the plurality of pages, each with the operational navigation bar, in an electronic storage device as the digital magazine.

17. The method according to claim 16, wherein the step of electronically laying out a plurality of pages includes:
obtaining electronic files corresponding to an original print magazine;
recombining fragmented portions of a graphics image stored in multiple ones of the electronic files into a single electronic file; and
reformatting and repositioning at least one of text and graphics, which appear across multiple pages of the original print magazine, to appear on the display screen as a single page of the digital magazine.

18. The method according to claim 11 or claim 16, wherein the display screen is oriented in a landscape format.

19. The method according to claim 11 or claim 16, wherein the display screen is oriented in a portrait format.

20. The method according to claim 11 or claim 16, further comprising the step of programming at least one of a hyperlink, a redirected page, an audio clip, and a video clip into the digital magazine.

21. The method according to claim 11 or claim 16, wherein the step of electronically laying out a plurality of pages includes utilizing a template to lay out one or more areas of a page.

22. The method according to claim 11 or claim 16, further comprising the step of compressing a storage size of the digital magazine before storing the digital magazine in the electronic storage device.
